(19) United States
(12) Patent Application Publication
(10) Pub. No.: US 2025/0055265 A1
(43) Pub. Date: Feb. 13, 2025

(54) Cable Feeding Device with a Bearing Unit for an Eccentric Bearing of a Pulling Means

(71) Applicant: Robert Bosch GmbH, Stuttgart (DE)

(72) Inventors: Fritz Schlegel, Stuttgart (DE); Andreas Schlegel, Leinfelden-Echterdingen (DE); Mario Ebel, Stuttgart (DE)

(21) Appl. No.: 18/794,924

(22) Filed: Aug. 5, 2024

(30) Foreign Application Priority Data
Aug. 7, 2023 (DE) 10 2023 207 550.4

(51) Int. Cl. H02G 1/08

(52) U.S. Cl. CPC H02G 1/081

(57) ABSTRACT

A cable feeding device includes a conveyor unit configured to transport at least one pulling member, in particular fish tapes, provided at least for pulling cables into conduits, with at least one receiving unit, in particular a pulling drum, which is configured to receive the at least one pulling member and which has at least one bearing unit, for a coiled storage of at least the at least one pulling member.

This application claims priority under 35 U.S.C. § 119 to patent application no. DE 10 2023 207 550.4, filed on Aug. 7, 2023 in Germany, the disclosure of which is incorporated herein by reference in its entirety.

### BACKGROUND

Fish tape and/or pulling rope that manually operate on the principle of a cable drum are already known. The pulling means is usually mounted on a shaft.

### SUMMARY

The disclosure is based on a cable feeding device with a conveyor unit for transporting at least one pulling means, in particular fish tapes, provided at least for pulling cables into conduits, with at least one pulling means receiving unit, in particular a pulling means drum, which is provided for receiving the pulling means and which has at least one bearing unit for coiled storage of at least the pulling means.

It is proposed that the bearing unit provides an eccentric bearing of the pulling means, in particular with respect to an axis of rotation of a bearing element of the bearing unit.

The embodiment of the cable feeding device according to the disclosure can advantageously adapt an ergonomics of the cable feeding device, in particular of the pulling means receiving unit, advantageously optimizing a compactness of the cable feeding device. In addition, the center of gravity of the cable feeding device can be shifted, thus further optimizing ergonomics and/or maneuverability. Furthermore, a functionality of the cable feeding device can be advantageously further increased, in particular with the eccentric bearing, which can lead to a thrust-like expulsion of the pulling means. Furthermore, the performance of the cable feeding device can be increased, in particular when driving the pulling means in and/or out, preferably with a multi-shaft bearing.

The cable feeding device is in particular configured as a fish tape pulling system and/or as a cable pulling system. The cable feeding device is in particular provided at least to feed in pulling means, such as fish tapes or ropes or the like. In addition, the cable feeding device may also be provided for dispensing and/or pushing of pulling means, such as fish tapes or ropes or the like. Fish tapes (also: electrician's snakes) are also known in particular as (cable) pull-in tapes and are preferably provided for laying new lines, such as electrical lines, preferably wires, in walls or in cable routings, in particular conduits. The pulling means, in particular the fish tape, the cable, or the like, may have a circular cross-section, an oval cross-section, a polygonal cross-section, or a cross-section of a flat tape. In particular, the pulling means may be formed in multiple pieces, for example as a woven thread made of individual strands or as a twisted strand. Preferably, the cross section of the pulling means is at least substantially constant along a longitudinal extension of the pulling means. The pulling means may also be formed from different materials, for example at least partially from a plastic, such as a nylon, at least partially from a metal, such as from elastic spring steel, at least partially from a fiberglass strip, etc. In particular, “provided” and/or “configured” shall be understood to mean specially programmed, construed, and/or equipped. In particular, the phrase “an object being provided and/or configured for a specific function” is intended to mean that the object fulfills and/or performs said specific function in at least one application state and/or operating state.

The conveyor unit may be provided for transporting the pulling means in two transport directions opposite to one another. The conveyor unit is preferably powered by a motor. In particular, the conveyor unit is intended at least for pulling the pulling means in or out. Additionally, the conveyor unit can also be provided for pushing (ejection) the pulling means. In particular, the conveyor unit is based on a rotary drive. In particular, the cable feeding device has at least one drive unit for generating energy for operating the conveyor unit. Preferably, the drive unit is provided to generate a driving force which coils and/or uncoils the pulling means in the pulling means receiving unit, in particular the pulling means drum. Preferably, the drive unit is an integral part of the cable feeding device, which is, for example, non-destructively and inseparably connected to the conveyor unit.

The conveyor unit is particularly preferred for driving out the pulling means, in particular by the conveyor unit driving the bearing shaft. In particular, a drive interface of the conveyor unit is connected to the bearing unit, in particular at least one bearing shaft, in a rotationally fixed/locked manner. Preferably, the conveyor unit is designed as a hub motor or the like for driving the bearing element of the bearing unit. Alternatively or additionally, the conveyor unit has a roll drive in the area of a pulling means output.

In particular, the pulling means receiving unit is provided for an at least largely enclosed bearing of the pulling means. This is to be understood in particular to mean that a large part of the components for storing the pulling means, in particular at least the bearing unit, is enclosed. Preferably, the pulling means is enclosed at least to a large extent in a coiled state of the pulling means, in particular enveloped. Particularly preferably, the conveyor unit drives the pulling means out of and/or in of the pulling means receiving unit during transportation. Preferably, in the coiled state of the pulling means, at least 70%, preferably at least 90% of the pulling means, is enclosed, and more preferably the entire pulling means is enclosed. In addition, “enclosing” is in particular to be understood as a wrapping of more than 50%, preferably more than 75%, and preferably more than 90% of a circumference of the pulling means in the coiled state in at least one circumferential direction, preferably in at least two circumferential directions extending in perpendicular planes. In particular, the cable feeding device has a pulling means output at which the pulling means is output to an environment of the cable feeding device. Preferably, the pulling means receiving unit forms a pulling means enclosure. In particular, the pulling means enclosure forms a storage space for the coiled pulling means.

In particular, the pulling means receiving unit at least partially forms a housing unit of the cable feeding device. Preferably, at least a major part of the conveyor unit is enclosed by the housing unit, in particular the housing unit at least partially supports the conveyor unit. By the fact that the housing unit at least partially supports the conveyor unit, it should be understood in particular that at least 50%, preferably at least 75% and preferably at least 90% of a total weight force of the conveyor unit acts on the housing unit.

Preferably, the bearing unit is intended to coil the pulling means, in particular to support it during coiling, wherein the pulling means is in direct contact with at least a part of the bearing unit, in particular with the bearing element of the bearing unit. In particular, the pulling means is coiled around the bearing element, in particular the bearing shaft, wherein preferably the bearing element, in particular the bearing shaft, extends and/or retracts. In particular, the bearing element is an element which supports and movably mounts the pulling means during storage. In particular, the bearing element is at least one element with at least one sliding surface, which is preferably in direct contact with the pulling means during storage, and/or the bearing shaft. Preferably, at least part of the bearing unit, preferably the bearing shaft, is mounted without rotation. The axis of rotation of the bearing element is in particular the axis of rotation of the bearing shaft. An eccentric bearing of the pulling means should be understood to mean that the axis of rotation of the bearing element, in particular the bearing shaft of the bearing unit, is offset or different from an axis of extension of the coiled pulling means, in particular the axis of extension of a smallest possible cylinder around the coiled pulling means. An axis of extension is the central axis or axis of extension of a smallest possible imaginary cylinder around the coiled/stored pulling means around the bearing unit, in particular in the pulling means receiving unit, which in particular forms the normal to a base surface of the coiled/mounted cylinder formed by the cylinder.

It is further proposed that the bearing unit has at least two bearing elements, which are each provided for bearing the same pulling means. Thereby, advantageously, an ergonomics of the cable feeding device, in particular of the pulling means receiving unit, can be adapted, advantageously optimizing a compactness of the cable feeding device. Advantageously, a shape of the pulling means receiving unit, in particular the pulling means housing, can be at least almost cuboidal. In particular, the pulling means in the pulling means receiving unit is wound at least around the two bearing elements. Preferably, the pulling means is wound eccentrically to the at least two bearing elements, wherein in particular an axis of extension of the bearing elements is offset or different to an axis of extension of the coiled pulling means, in particular the axis of extension of a smallest possible cylinder around the coiled pulling means. Preferably, the conveyor unit is designed to coil and/or uncoil the pulling means around the bearing elements. Preferably, the bearing elements are designed separately from one another, in particular the axis of rotation of the bearing elements are separate from one another, in particular a distance between the bearing elements, in particular the axis of rotation, is at least twice, preferably at least three times, particularly preferably at least four times as large as a circumference of the bearing elements. Preferably, the bearing elements, in particular the axis of rotation of the bearing elements, are arranged at least substantially parallel to each other. Alternatively, the bearing elements, in particular the axis of rotation of the bearing elements, are skewed or angularly offset, in particular by at least 5°, preferably by at least 10°, advantageously by at least 20°, particularly preferably by at least 45° and especially advantageously by at least 90°. This can advantageously further increase flexibility in the design of the pulling means enclosure.

It is also proposed that at least one of the bearing elements forms a bearing shaft. This can advantageously ensure a drive of at least one of the bearing elements. In particular, at least one of the bearing elements is the bearing shaft, in particular a non-rotating bearing shaft. Preferably, all of the bearing elements are bearing shafts, in particular non-rotating bearing shafts. In particular, at least one of the bearing elements, preferably one of the bearing elements designed as a bearing shaft, is connected to the conveyor unit. In particular, when the bearing element is designed as a bearing shaft, the axis of rotation of the bearing shaft is identical to an axis of extension of the bearing element. Preferably, the conveyor unit is connected to the bearing shaft in a rotationally fixed/locked manner, whereby the at least one further bearing element, in particular as a bearing shaft, is designed to be passive, in particular free-running In particular, a drive interface of the conveyor unit is connected to at least the bearing shaft in a rotationally fixed/locked manner. In particular, the bearing shaft, which is connected to the conveyor unit in a rotationally fixed/locked manner, is to be understood as a drive shaft, which is preferably driven by a hub drive of the conveyor unit. Preferably, the other bearing element, in particular the other bearing shaft, rotates passively, preferably due to the transport aid. Alternatively, both bearing elements, in particular as a bearing shaft, are connected to the conveyor unit in a rotationally fixed/locked manner.

Furthermore, it is proposed that the bearing unit has a transport aid which guides and/or drives the at least two bearing elements. This can advantageously optimize a bearing of the pulling means in the pulling means receiving unit, in particular around the bearing unit. In particular, the transport aid is designed as a belt, a chain, a band, a rope and/or the like. Preferably, the transport aid rotates around the bearing elements of the bearing unit. Particularly preferably, the bearing elements are connected to the transport aid, in particular wrapped around by the transport aid, preferably so that the bearing elements, in particular as bearing shafts, run synchronously. In particular, the transport aid is intended to connect the bearing shaft, which is connected to the conveyor unit, preferably the drive shaft, to the further bearing element, in particular the further bearing shaft, preferably the free-running bearing shaft. Preferably, the pulling means is wrapped around the transport aid in the pulling means receiving unit. Particularly preferably, the bearing unit is designed as a belt conveyor or chain conveyor, especially with the at least two bearing elements guiding and/or driving the rotating transport aid, in particular as a belt or chain. Preferably, the axis of rotation of the stored pulling means in the pulling means receiving unit is eccentric to the bearing elements of the bearing unit and at least almost identical to an axis of rotation of the transport aid. In at least one further embodiment of the cable feeding device according to the disclosure, the conveyor unit has a drive roller which engages in the transport aid to drive the transport aid and/or transmits force to the transport aid via friction. In particular, the drive roller is in direct contact with the transport aid. Preferably, the drive roller drives the bearing elements, in particular as bearing shafts, so that the pulling means extends and/or retracts.

Furthermore, it is proposed that the bearing unit, in particular the transport aid, has at least one coupling element for coupling with the pulling means. This can advantageously ensure a transmission of force from the transport aid and the pulling means. Preferably, the coupling element is arranged on the transport aid and/or on the bearing element. In particular, the coupling element is provided for transmitting force from the transport aid, in particular at least one of the bearing elements, in particular the bearing shaft, to the pulling means. In particular, the coupling element is provided to provide a clamping connection and/or positive connection with the pulling means, wherein the coupling element is designed, for example, as a clamp, plug connector, screw clamp, luster clamp, snap hook or the like. Preferably, the pulling means has a coupling element that corresponds to the coupling element of the bearing unit. The coupling element is particularly preferably designed as a coupling pin, which is provided in particular for coupling, preferably without rotation, into a recess in the coupling element of the pulling means. In one embodiment of the transport aid as a chain, for example, the coupling element is a chain link, which is provided for fastening the pulling means. In at least one further embodiment, the transport aid, in particular as a belt, has a roughness which accommodates the pulling means or the coupling element of the pulling means, which has advantageous properties for coupling with a rough surface.

It is conceivable that the coupling element provides a detachable coupling of the pulling means. The term “detachable” is in particular understood to mean “non-destructively separable”. In particular, the coupling of the coupling element can be released with a tool, in particular with a hexagon wrench, screwdriver and/or a tool specially developed for the coupling unit, and/or manually, in particular non-destructively separable. Particularly preferably, the coupling element is provided for coupling to a plurality of, particularly different, pulling means.

Furthermore, at least three bearing elements or four bearing elements are also conceivable, which are designed accordingly, whereby the pulling means, in particular the transport aid, is wrapped around the bearing elements.

It is also proposed that the bearing unit has at least one bearing element, in particular in the form of a bearing shaft, which is mounted such that it can rotate eccentrically. This can advantageously provide a thrust-like expulsion of the pulling means. In particular, the eccentrically mounted bearing element, especially with the conveyor unit, is intended to generate an additional movement which superimposes and/or interrupts the purely continuous retraction and/or the purely continuous ejection. In particular, the movement deviating from the pure retraction and pure ejection is intended to free a tilted, jammed or blocked pulling element, for example in a shaft tube, and/or to prevent tilting, jamming or blocking of the pulling element as early as possible. In particular, the axis of rotation of the eccentrically mounted bearing element is different from an axis of symmetry, in particular an axis of extension, of the bearing element.

In addition, it is proposed that the pulling means receiving unit has at least the pulling means enclosure, which is intended to enclose at least a large part of the bearing unit, in particular the stored pulling means. This can advantageously realize an encapsulation of the pulling means, in particular from the environment, which advantageously prevents contamination of the bearing unit, in particular of the bearing elements, in particular during use and/or storage of the cable feeding device. In particular, the pulling means receiving unit, in particular the pulling means enclosure, is at least almost polyhedron-shaped or rotationally asymmetrical.

It is further proposed that the pulling means receiving unit, in particular the pulling means enclosure, is designed to be separable from the conveyor unit. As a result, a change of pulling means can advantageously be realized as simply as possible. Furthermore, the conveyor unit can be mounted as simply as possible, in particular due to the polyhedron-shaped design of the pulling means enclosure, and in particular a plurality of pulling means enclosures can be accommodated in one pulling means enclosure bearing. In particular, the pulling means receiving unit is designed to be interchangeable. Preferably, the pulling means receiving unit is detachably connected to the housing unit. In particular, the pulling means receiving unit is designed to be separable from the conveyor unit, in particular the drive unit. Preferably, the conveyor unit has a conveyor interface, preferably in the housing unit, which is provided for transmitting force from the drive unit to the pulling means receiving unit, in particular to a corresponding conveyor interface of the pulling means receiving unit.

It is also proposed that the bearing unit is at least partially integral with the conveyor unit. This can advantageously provide a direct drive of the bearing unit. By the fact that two units are “partially in one piece”, it should be understood in particular that the units have at least one, in particular at least two, advantageously at least three common elements which are a component, in particular a functionally important component, of both units. In particular, the conveyor unit comprises the bearing elements and the belt in the belt conveyor, which move the pulling means. Preferably, the bearing elements are either directly connected to a drive element of the conveyor unit or axially freely mounted. In particular, the pulling means receiving unit is firmly connected to the housing unit, in particular the conveyor unit, whereby the pulling means receiving unit is preferably prevented from loosening.

Further, a pulling means receiving unit of a cable feeding device is proposed. The embodiment of the pulling means receiving unit according to the disclosure can advantageously be used to adapt the ergonomics of the pulling means receiving unit, advantageously optimizing the compactness of the pulling means receiving unit. In addition, a center of gravity of the cable feeding device can be shifted with the pulling means receiving unit, thereby further optimizing the ergonomics and/or manageability. Furthermore, a functionality of the cable feeding device can be advantageously further increased, in particular with the eccentric bearing of the pulling means receiving unit, which can lead to a thrust-like expulsion of the pulling means. In particular, the pulling means receiving unit has a coupling unit which is intended to be coupled, in particular detachably, to the housing unit of the cable feeding device. As a result, the pulling means receiving unit can be advantageously coupled to different drive units with different power from different cable feeding devices.

Furthermore, a system is proposed having the cable feeding device and having at least the pulling means. The system according to the disclosure can advantageously be used to adapt the ergonomics of the cable feeding device, in particular of the pulling means receiving unit, can be adapted, advantageously optimizing a compactness of the cable feeding device. In addition, the center of gravity of the cable feeding device can be shifted, thus further optimizing ergonomics and/or maneuverability. Furthermore, a functionality of the cable feeding device can be advantageously further increased, in particular with the eccentric bearing, which can lead to a thrust-like expulsion of the pulling means. In particular, the pulling means has a coupling element which is provided for coupling with the coupling element of the bearing unit.

The cable feeding device according to the disclosure, the pulling means receiving unit according to the disclosure and the system according to the disclosure are not intended to be limited to the application and embodiment described above. In particular, the cable feeding device according to the disclosure, the pulling means receiving unit according to the disclosure and the system according to the disclosure can have a number of individual elements, components and units that differs from a number mentioned herein in order to fulfill a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. Two exemplary embodiments of the disclosure are shown in the drawings. The drawings, the description, and the claims contain numerous features in combination. A person skilled in the art will appropriately also consider the features individually and combine them into additional advantageous combinations.

Shown are:

FIG. 1A system with a cable feeding device and with a pulling means,

FIG. 2 the cable feeding device with a dismantled pulling means receiving unit,

FIG. 3 a bearing unit of the cable feeding device, and

FIG. 4 an alternative embodiment of a bearing unit of the cable feeding device.

### DETAILED DESCRIPTION

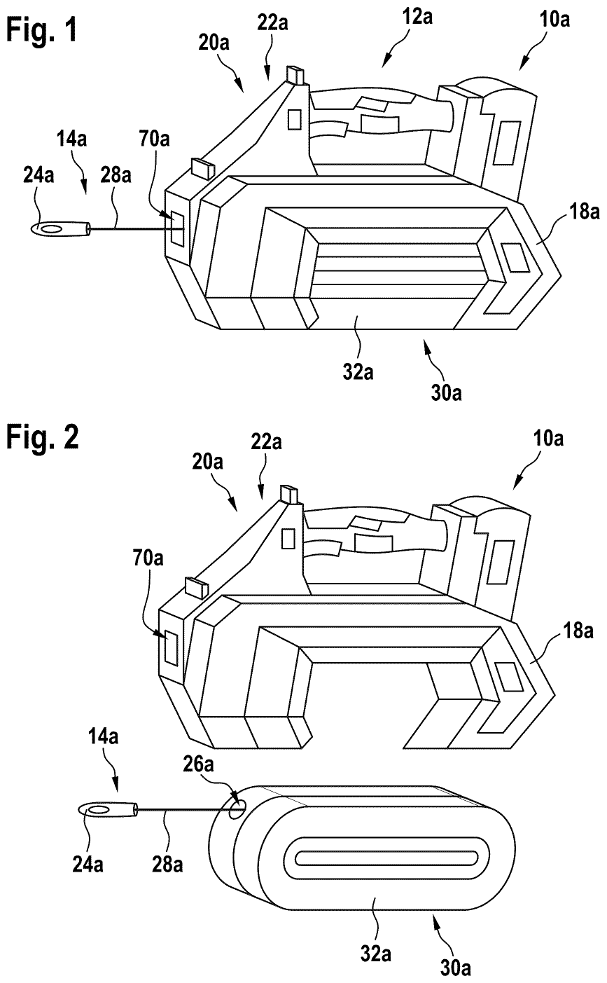

FIG. 1 shows a schematic perspective view of a system 12a with a cable feeding device 10a. The system 12a comprises the cable feeding device 10a. The system 12a, in particular the cable feeding device 10a, comprises a pulling means 14a. The pulling means 14a is intended at least for pulling cables, in particular electrical lines, into conduits. The pulling means 14a is provided to transmit a tensile force of the system 12a to the cable. The pulling means 14a comprises a pulling means head 24a. The pulling means 14a comprises a pulling means cable 28a. The pulling means head 24a is provided for reversibly attaching the cable to the pulling means, for feeding the cable into conduits. The pulling means, in particular the pulling means cable, is configured as a wire strand made of spring steel, for example. However, other embodiments of the pulling means 14a are also conceivable.

The cable feeding device 10a comprises a housing unit 18a. The cable feeding device 10a has a pulling means receiving unit 30a. The pulling means receiving unit 30a is provided for mounting the pulling means 14a. The pulling means receiving unit 30a is provided for an at least largely enclosed mounting of the pulling means 14a. The pulling means receiving unit 30a comprises a pulling means enclosure 32a enclosing at least a majority of the pulling means 14a in the coiled state. The pulling means enclosure 32a forms a storage space for the coiled pulling means 14a. The pulling means receiving unit 30a is configured as a pulling means drum. The pulling means receiving unit 30a is provided for a receiving of the pulling means 14a. The pulling means receiving unit 30a is at least almost polyhedron-shaped or rotationally asymmetrical. The pulling means enclosure 32a is at least almost polyhedron-shaped or rotationally asymmetrical (see also FIG. 2).

The pulling means receiving unit 30a has a pulling means output 26a. The pulling means 14a exits the pulling means receiving unit 30a at the pulling means output 26a. The pulling means output 26a is arranged on an outer circumference on a lateral surface of the pulling means receiving unit 30a. The housing unit 18a has a pulling means output 70a. The pulling means 14a emerges from the housing unit 18a at the pulling means output 70a. The pulling means output 70a is arranged on an outer circumference on a lateral surface of the housing unit 18a.

The cable feeding device 10a has a conveyor unit 20a. The housing unit 18a partially encloses the conveyor unit 20a. The housing unit 18a carries the conveyor unit 20a. The conveyor unit 20a is arranged on an outer circumference on a lateral surface of the cylindrical pulling means receiving unit 30a. The conveyor unit 20a is provided for transporting the pulling means 14a along at least one transport direction, in particular along at least two transport directions. The conveyor unit 20a is provided for transporting the pulling means 14a along a retraction direction and/or along an ejection direction. The conveyor unit 20a is provided for pulling the pulling means 14a during a cable pulling process. The conveyor unit 20a is provided for pushing the pulling means 14a during an insertion process, in which the pulling means 14a is threaded into the duct and pushed in. The conveyor unit 20a is intended to drive out and/or drive in the pulling means 14a from the pulling means receiving unit 30a during transportation.

The conveyor unit 20a is set up to coil and/or uncoil the pulling means 14a in the pulling means receiving unit 30a. The conveyor unit 20a comprises at least one drive unit 22a. The drive unit 22a is provided for generating a driving force which coils and/or uncoils the pulling means 14a in the pulling means receiving unit 30a. The drive unit 22a is an integral part of the cable feeding device 10a, which is connected, for example, non-destructively and inseparably to the pulling means receiving unit 30a and the conveying elements of the conveyor unit 20a of the pulling means 14a. The conveyor unit 20a at least partially forms the pulling means receiving unit 30a. In an alternative embodiment of the cable feeding device 10a, the housing unit 18a has at least one housing interface. An external drive unit 22a can be coupled to the cable feeding device 10a via the housing interface. For example, the external drive unit 22a is a hand-held power tool.

FIG. 2 shows the cable feeding device 10a with the dismantled pulling means receiving unit 30a. The pulling means receiving unit 30a is detachably connected to the housing unit 18a. The pulling means receiving unit 30a is designed to be separable from the conveyor unit 20a. The pulling means enclosure 32a is designed to be separable from the conveyor unit 20a. The pulling means receiving unit 30a is designed to be replaceable. The pulling means receiving unit 30a has a coupling unit. The coupling unit is intended to enter into a detachable coupling with the housing unit 18a of the cable feeding device 10a.

The pulling means receiving unit 30a is designed to be separable from the conveyor unit 20a, in particular the drive unit 22a. The conveyor unit 20a has a conveyor interface. The conveyor interface is arranged on the housing unit 18a. The conveyor interface is provided for the transmission of force from the drive unit 22a to the pulling means receiving unit 30a. The pulling means receiving unit 30a has a conveyor interface corresponding to the conveyor interface. The corresponding conveyor interface is provided to absorb the force of the conveyor unit 20a.

During the coupling process, the coupling unit is provided to receive the pulling means receiving unit 30a. After a coupling process of the pulling means receiving unit 30a with the housing unit 18a, the pulling means 14a is guided through the pulling means output 26a of the pulling means receiving unit 30a and through the pulling means output 70a of the housing unit 18a.

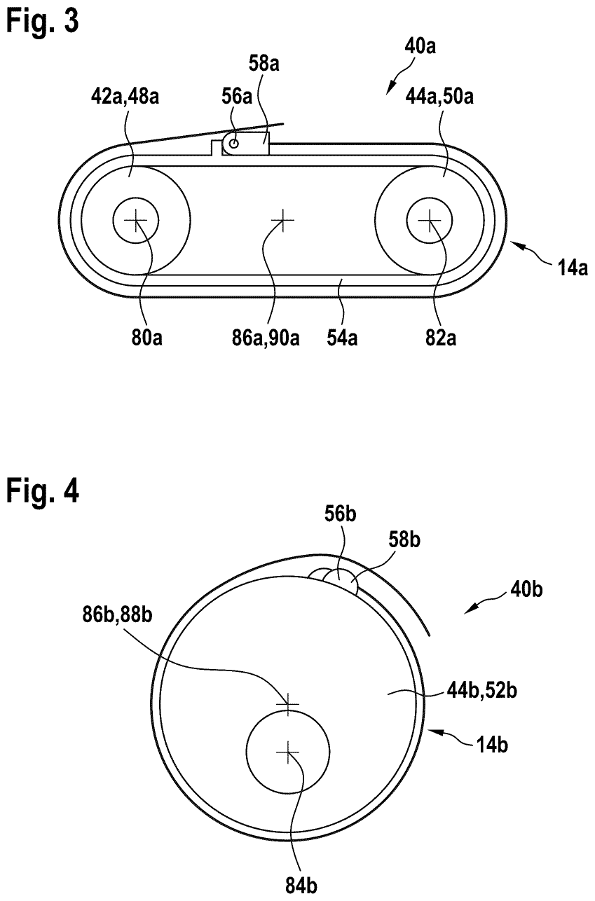

FIG. 3 shows a bearing unit 40a of the cable feeding device 10a in a schematic illustration. The cable feeding device 10a has the bearing unit 40a. The bearing unit 40a is provided for a coiled storage of at least the pulling means 14a. The pulling means enclosure 32a surrounds at least a large part of the bearing unit 40a. The bearing unit 40a is provided for coiling the pulling means 14a. The bearing unit 40a provides an eccentric bearing for the pulling means 14a.

The bearing unit 40a is provided to support the pulling means 14a during coiling. The pulling means 14a is provided in a direct contact with at least a part of the bearing unit 40a. The bearing unit 40a has a bearing element 42a. The pulling means 14a is in direct contact with the bearing element 42a of the bearing unit 40a. The bearing unit 40a provides an eccentric bearing of the pulling means 14a with respect to an axis of rotation 80a of the bearing element 42a of the bearing unit 40a. The axis of rotation 80a of the bearing element 42a is offset or different from an axis of extension 86a of the coiled or stored pulling means 14a. The axis of extension 86a of the coiled or stored pulling means 14a is the axis of extension 86a of a smallest possible cylinder around the coiled pulling means 14a.

The bearing unit 40a has at least two bearing elements 42a, 44a, which are each provided for bearing the same pulling means 14a. The pulling means 14a in the pulling means receiving unit 30a is wound around at least the two bearing elements 42a, 44a. The pulling means 14a is wound eccentrically to the at least two bearing elements 42a, 44a. An axis of rotation 80a, 82a of the bearing elements 42a, 44a is offset or different from the axis of extension 86a of the coiled pulling means 14a. The conveyor unit 20a is intended to coil and/or uncoil the pulling means 14a around the bearing elements 42a, 44a. The bearing elements 42a, 44a are formed separately from one another. The axes of rotation 80a, 82a of the bearing elements 42a, 44a are separate from one another. The bearing elements 42a, 44a are arranged at least substantially parallel to one another. The axis of rotation 80a, 82a of the bearing elements 42a, 44a are arranged at least substantially parallel to each other. In an alternative embodiment of the cable feeding device 10a according to the disclosure, the bearing elements 42a, 44a are skewed or angularly offset. The axis of rotation 80a, 82a of the bearing elements 42a, 44a are skewed or angularly offset.

At least one of the bearing elements 42a, 44a is designed as a bearing shaft 48a, 50a. The bearing shaft 48a, 50a is designed without rotation. The axis of rotation 80a, 82a of the bearing element 42a, 44a is in particular the axis of rotation 80a, 82a of the bearing shaft 48a, 50a. The bearing elements 42a, 44a are designed as bearing shafts 48a, 50a. At least one of the bearing elements 48a, 50a designed as a bearing shaft 42a, 44a is connected to the conveyor unit 20a. When the bearing element 42a, 44a is designed as a bearing shaft 48a, 50a, the axis of rotation 80a, 82a of the bearing shaft 48a, 50a is identical to an axis of extension of the bearing element 42a, 44a. The conveyor unit 20a is connected to the bearing shaft 48a, 50a in a rotationally fixed/locked manner, wherein the at least one further bearing element 42a, 44a, in particular as a bearing shaft 48a, 50a, is designed to be passive, in particular free-running. A drive interface of the conveyor unit 20a is connected to at least the bearing shaft 48a, 50a in a rotationally fixed/locked manner. The bearing shaft 48a, 50a, which is connected to the conveyor unit 20a in a rotationally fixed/locked manner, is to be understood as a drive shaft. Alternatively, both bearing elements 42a, 44a are connected to the conveyor unit 20a as a bearing shaft 48a, 50a in a rotationally fixed/locked manner.

Alternatively, the bearing unit 40a has at least one bearing element 42a, 44a which has a sliding surface. The sliding surface is in direct contact with the pulling means 14a during storage. The sliding surface allows the pulling means 14a to slide around the bearing element 42a, 44a.

The bearing element 42a, 44a drives the pulling means 14a out and/or in. The bearing element 42a, 44a is an element that supports the pulling means 14a during storage and supports it movably. The conveyor unit 20a is designed to coil and/or uncoil the pulling means 14a onto the bearing element 42a, 44a. The conveyor unit 20a is designed to coil and/or uncoil the pulling means 14a onto the bearing shaft 48a, 50a. The conveyor unit 20a is at least partially designed as a hub motor, which sets the movably mounted bearing shaft 48a, 50a in rotation.

The bearing unit 40a has a transport aid 54a, which guides and/or drives the at least two bearing elements 42a, 44a. The pulling means 14a is wound around the transport aid 54a in the pulling means receiving unit 30a. The other bearing shaft 48a, 50a rotates passively due to the transport aid 54a. The transport aid 54a rotates around the bearing elements 42a, 44a of the bearing unit 40a. The bearing elements 42a, 44a are connected to the transport aid 54a. The bearing elements 42a, 44a are surrounded by the transport aid 54a. The bearing elements 42a, 44a designed as bearing shaft 48a, 50a run at least almost synchronously due to the transport aid 54a. The transport aid 54a is intended to connect the bearing shaft 48a, 50a, which is connected to the conveyor unit 20a, to the further bearing element 42a, 44a. The transport aid 54a is intended to connect the drive shaft to the free-running bearing shaft 48a, 50a. The axis of extension 86a of the stored pulling means 14a in the pulling means receiving unit 30a is eccentric to the bearing elements 42a, 44a of the bearing unit 40a and is at least almost identical to an axis of rotation 90a of the transport aid 54a.

The transport aid 54a is configured as a belt. The bearing unit 40a is configured as a belt conveyor. The belt conveyor has at least two bearing elements 42a, 44a which guide and/or drive the circulating belt. Alternatively, the transport aid 54a is designed as a chain. The bearing unit 40a is designed as a chain conveyor. The chain conveyor has at least two bearing elements 42a, 44a which guide and/or drive the circulating chain.

In at least one further embodiment of the cable feeding device 10a according to the disclosure, the conveyor unit 20a has a drive roller. The drive roller engages with the transport aid 54a to drive the transport aid 54a. Alternatively, the drive roller transmits a driving force to the transport aid 54a via friction. The drive roller is in direct contact with the transport aid 54a. The drive roller is provided to drive the bearing elements 42a, 44a as free-running bearing shafts 48a, 50a, so that the pulling means 14a extends and/or retracts.

The bearing unit 40a has at least one coupling element 56a for coupling with the pulling means 14a. The transport aid 54a has the coupling element 56a for coupling with the pulling means 14a. The coupling element 56a is arranged on the transport aid 54a. The coupling element 56a is provided for transmitting force from the transport aid 54a to the pulling means 14a. The coupling element 56a is provided for transmitting force from one of the bearing elements to the pulling means 14a. The coupling element 56a is provided for providing a clamping connection and/or positive connection with the pulling means 14a. The coupling element 56a is designed, for example, as a clamp, plug connector, screw clamp, luster clamp, snap hook or the like. The pulling means 14a has a coupling element 58a corresponding to the coupling element 56a of the bearing unit 40a.

In at least one further embodiment of the device according to the disclosure, the bearing unit 40a is formed at least partially integrally with the conveyor unit 20a. The pulling means receiving unit 30a is fixedly connected to the conveyor unit 20a. The bearing elements 42a, 44a are directly connected to a drive element of the conveyor unit 20a. The pulling means receiving unit 30a is firmly connected to the housing unit 18a. Detachment of the pulling means receiving unit 30a from the housing unit 18a is prevented.

FIG. 4 shows a further embodiment of the disclosure. The following descriptions and the drawings are substantially limited to the differences between the exemplary embodiments, whereby reference can also be made in principle to the drawings and/or the description of the other exemplary embodiments, in particular FIGS. 1 to 3, with regard to components with the same reference numerals, in particular with regard to components having the same reference signs. To differentiate between the exemplary embodiments, the letter a is placed after the reference numerals of the exemplary embodiment in FIGS. 1 to 3. In the exemplary embodiments in FIG. 3, the letter a is replaced by the letter b.

FIG. 4 shows an alternative embodiment of a bearing unit 40b of a cable feeding device 10b. The bearing unit 40b has at least one bearing element 46b. The bearing element 46b is mounted such that it can rotate eccentrically. A pulling means 14b is wound around the eccentrically mounted bearing element 46b. The bearing element 46b is provided for an eccentric bearing of the pulling means 14b. An axis of rotation 84b of the bearing element 46b is different or offset from an axis of extension 86b of a coiled or stored pulling means 14b. In the case of the eccentrically mounted bearing element 46b, the axis of rotation 84b is different from an axis of symmetry 88b of the bearing element 46b. The bearing element 46b is designed as a bearing shaft 52b. The bearing shaft 52b is eccentrically mounted.

The eccentrically mounted bearing element 46b is intended to generate an additional movement which is superimposed on and/or interrupts the purely continuous retraction and/or the purely continuous discharge. The eccentrically mounted bearing element 46b is provided with the conveyor unit 20b for generating an additional movement which superimposes and/or interrupts the pure continuous retraction and/or the pure continuous ejection. The movement deviating from the pure retraction and pure ejection is intended to free a tilted, jammed or blocked pulling element, for example in a shaft tube, and/or to prevent tilting, jamming or blocking of the pulling element as early as possible.

A coupling element 56b is arranged on the eccentrically mounted bearing element 46b. The coupling element 56b is provided for coupling with a corresponding coupling element 58b of the pulling means 14b.

What is claimed is:

1. A cable feeding device, comprising:
a conveyor unit configured to transport at least one pulling member, the at least one pulling member configured for pulling cables into conduits; and
at least one receiving unit configured to receive the at least one pulling member, the at least one receiving unit including at least one bearing unit configured for a coiled storage of the at least one pulling member,
wherein the at least one bearing unit includes an eccentric bearing of the at least one pulling member with respect to an axis of rotation of a bearing element of the at least one bearing unit.

2. The cable feeding device according to claim 1, wherein the at least one bearing unit has at least two bearing elements each configured to bear the at least one pulling member.

3. The cable feeding device according to claim 2, wherein at least one of the bearing elements forms a bearing shaft.

4. The cable feeding device according to claim 2, wherein the at least one bearing unit further includes a transport aid configured to guide and/or to drive the at least two bearing elements.

5. The cable feeding device according to claim 4, wherein the transport aid has at least one coupling element configured to couple with the at least one pulling member.

6. The cable feeding device according to claim 1, wherein the bearing element is configured as a bearing shaft mounted to rotate eccentrically.

7. The cable feeding device according to claim 1, wherein the at least one receiving unit includes at least one enclosure configured to enclose the at least one bearing unit and the at least one pulling member in a stored configuration.

8. The cable feeding device according to claim 7, wherein the at least one enclosure is separable from the conveyor unit.

9. The cable feeding device according to claim 1, wherein the at least one bearing unit is formed at least partially integrally with the conveyor unit.

10. A receiving unit of a cable feeding device according to claim 1.

11. A system, comprising:
a cable feeding device according to claim 1; and
at least one pulling member.
